(19) United States
(12) Patent Application Publication
(10) Pub. No.: US 2024/0224327 A1
(43) Pub. Date: Jul. 4, 2024

(54) APPARATUS, SYSTEM, AND METHOD OF WIRELESS COMMUNICATION DURING A TRANSMIT OPPORTUNITY (TXOP)

(71) Applicant: INTEL CORPORATION, SANTA CLARA, CA (US)

(72) Inventors: Ofir Klein, Petah Tikva (IL); Ehud Reshef, Qiryat Tivon (IL); Uri Parker, Shimshit (IL); Danny Alexander, Neve Efraim Monoson (IL); Nevo Idan, Zichron Ya'akov (IL); Maxim Stepanov, Jerusalem (IL); Michael Shachar, Kfar Glikson (IL)

(73) Assignee: INTEL CORPORATION, SANTA CLARA, CA (US)

(21) Appl. No.: 18/090,991

(22) Filed: Dec. 29, 2022

(51) Int. Cl. H04W 74/08

(52) U.S. Cl. CPC H04W 74/0816; H04W 74/0866

(57) ABSTRACT

For example, a wireless communication device may be configured to transmit a reservation frame to reserve a wireless communication medium for a Transmit Opportunity (TxOP). For example, the TxOP may be configured to cover a first reserved duration and a second reserved duration. For example, the first reserved duration may be configured for at least one self-transmission of the STA, and the second reserved duration may be configured for communication of at least one non-self-transmission by the STA. For example, the wireless communication device may be configured to transmit the at least one self-transmission during the first duration. For example, the self-transmission may be configured for transmission from a transmitter of the STA to a receiver of the STA.

### TECHNICAL FIELD

Aspects described herein generally relate to wireless communication during a Transmit Opportunity (TxOP).

### BACKGROUND

A wireless communication device may communicate one or more self-transmissions.

A self-transmission may include, for example, a transmission from a transmitter of the wireless communication device to a receiver of the wireless communication device.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of a communication scheme including communications performed by a wireless communication station (STA) and an Access Point (AP), in accordance with some demonstrative aspects.

FIG. 3 is a schematic illustration of a communication scheme including communications performed by a STA and an AP, in accordance with some demonstrative aspects.

FIG. 4 is a schematic illustration of a communication scheme including communications performed by a STA and an AP, in accordance with some demonstrative aspects.

FIG. 5 is a schematic illustration of a communication scheme including communications performed by a STA and an AP, in accordance with some demonstrative aspects.

FIG. 6 is a schematic illustration of a communication scheme including communications performed by an AP and a plurality of STAs, in accordance with some demonstrative aspects.

FIG. 7 is a schematic illustration of a communication scheme including communications performed by a STA and an AP, in accordance with some demonstrative aspects.

FIG. 8 is a schematic flow-chart illustration of a method of wireless communication during a Transmit Opportunity (TxOP), in accordance with some demonstrative aspects.

FIG. 9 is a schematic flow-chart illustration of a method of wireless communication during a TxOP, in accordance with some demonstrative aspects.

FIG. 10 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IOT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing IEEE 802.11 standards (including IEEE 802.11-2020 (IEEE 802.11-2020, IEEE Standard for Information Technology—Telecommunications and Information Exchange between Systems Local and Metropolitan Area Networks—Specific Requirements; Part 11: Wireless LAN Medium Access Control (MAC) and Physical Layer (PHY) Specifications, December, 2020)) and/or future versions and/or derivatives thereof, devices and/or networks operating in accordance with existing cellular specifications and/or protocols, and/or future versions and/or derivatives thereof, units and/or devices which are part of the above networks, and the like.

Some aspects may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), 4G, Fifth Generation (5G), or Sixth Generation (6G) mobile networks, 3GPP, Long Term Evolution (LTE), LTE advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that may be integrated with a computer, or a peripheral that may be attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated or group), and/or memory (shared. Dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

Some demonstrative aspects may be used in conjunction with a WLAN, e.g., a WiFi network. Other aspects may be used in conjunction with any other suitable wireless communication network, for example, a wireless area network, a “piconet”, a WPAN, a WVAN and the like.

Some demonstrative aspects may be used in conjunction with a wireless communication network communicating over a sub-10 Gigahertz (GHz) frequency band, for example, a 2.4 GHz frequency band, a 5 GHz frequency band, a 6 GHz frequency band, and/or any other frequency band below 10 GHz.

Some demonstrative aspects may be used in conjunction with a wireless communication network communicating over an Extremely High Frequency (EHF) band (also referred to as the “millimeter wave (mmWave)” frequency band), for example, a frequency band within the frequency band of between 20 Ghz and 300 GHz, for example, a frequency band above 45 GHz, e.g., a 60 GHz frequency band, and/or any other mmWave frequency band.

Some demonstrative aspects may be used in conjunction with a wireless communication network communicating over the sub-10 GHz frequency band and/or the mmWave frequency band, e.g., as described below. However, other aspects may be implemented utilizing any other suitable wireless communication frequency bands, for example, a 5G frequency band, a frequency band below 20 GHz, a Sub 1 GHz (SIG) band, a WLAN frequency band, a WPAN frequency band, and the like.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

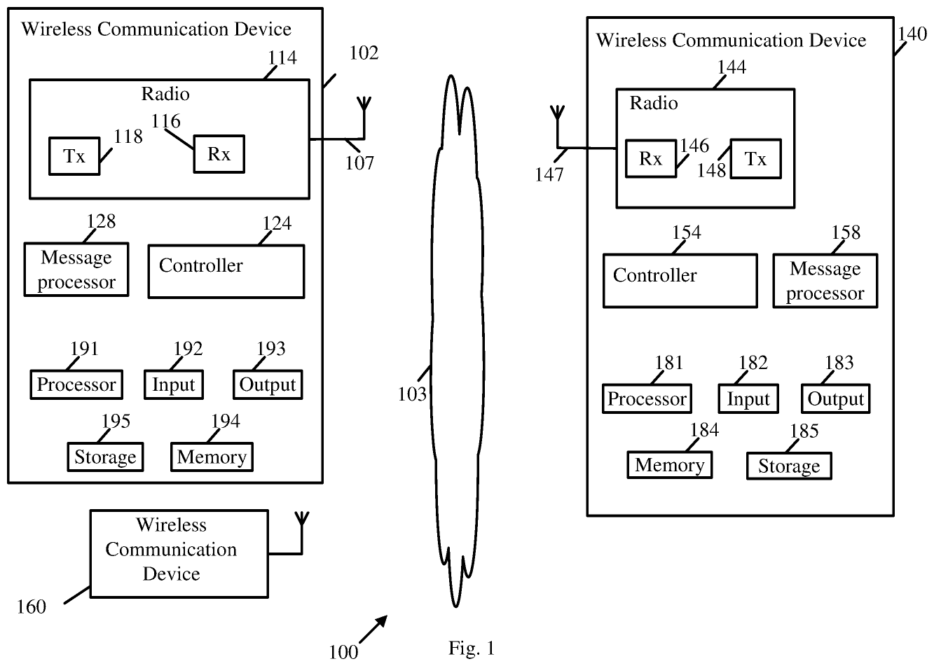

Reference is made to FIG. 1, which schematically illustrates a system 100, in accordance with some demonstrative aspects.

As shown in FIG. 1, in some demonstrative aspects, system 100 may include one or more wireless communication devices. For example, system 100 may include a wireless communication device 102, a wireless communication device 140, a wireless communication device 160, and/or one more other devices.

In some demonstrative aspects, devices 102, 140, and/or 160 may include a mobile device or a non-mobile, e.g., a static, device.

For example, devices 102, 140, and/or 160 may include, for example, a UE, an MD, a STA, an AP, a Smartphone, a PC, a desktop computer, a mobile computer, a laptop computer, an Ultrabook™ computer, a notebook computer, a tablet computer, a server computer, a handheld computer, an Internet of Things (IOT) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a video source, an audio source, a video sink, an audio sink, a stereo tuner, a broadcast radio receiver, a digital audio player, a speaker, an audio receiver, an audio amplifier, a gaming device, a data source, a data sink, a media player, a television, a music player, a smart device such as, for example, lamps, climate control, car components, household components, appliances, and the like.

In some demonstrative aspects, device 102 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Devices 102 and/or 140 may optionally include other suitable hardware components and/or software components. In some demonstrative aspects, some or all of the components of one or more of devices 102 and/or 140 may be enclosed in a common housing or packaging, and may be interconnected or operably associated using one or more wired or wireless links. In other aspects, components of one or more of devices 102 and/or 140 may be distributed among multiple or separate devices.

In some demonstrative aspects, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications. Processor 181 may execute instructions, for example, of an OS of device 140 and/or of one or more suitable applications.

In some demonstrative aspects, input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 194 and/or memory unit 184 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a disk drive, a solid-state drive (SSD), and/or other suitable removable or non-removable storage units. Memory unit 194 and/or storage unit 195, for example, may store data processed by device 102. Memory unit 184 and/or storage unit 185, for example, may store data processed by device 140.

In some demonstrative aspects, wireless communication devices 102, 140, and/or 160 may be capable of communicating content, data, information and/or signals via a wireless medium (WM) 103. In some demonstrative aspects, wireless medium 103 may include, for example, a radio channel, a cellular channel, an RF channel, a Wi-Fi channel, a 5G channel, an IR channel, a Bluetooth (BT) channel, a Global Navigation Satellite System (GNSS) Channel, and the like.

In some demonstrative aspects, WM 103 may include one or more wireless communication frequency bands and/or channels. For example, WM 103 may include one or more channels in a sub-10 Ghz wireless communication frequency band, for example, one or more channels in a 2.4 GHz wireless communication frequency band, one or more channels in a 5 GHz wireless communication frequency band, and/or one or more channels in a 6 GHz wireless communication frequency band. For example, WM 103 may additionally or alternatively include one or more channels in a mmWave wireless communication frequency band. In other aspects, WM 103 may include any other type of channel over any other frequency band.

In some demonstrative aspects, device 102, device 140, and/or device 160 may include one or more radios including circuitry and/or logic to perform wireless communication between devices 102, 140, 160, and/or one or more other wireless communication devices. For example, device 102 may include at least one radio 114, and/or device 140 may include at least one radio 144.

In some demonstrative aspects, radio 114 and/or radio 144 may include one or more wireless receivers (Rx) including circuitry and/or logic to receive wireless communication signals, RF signals, frames, blocks, transmission streams, packets, messages, data items, and/or data. For example, radio 114 may include at least one receiver 116, and/or radio 144 may include at least one receiver 146.

In some demonstrative aspects, radio 114 and/or radio 144 may include one or more wireless transmitters (Tx) including circuitry and/or logic to transmit wireless communication signals, RF signals, frames, blocks, transmission streams, packets, messages, data items, and/or data. For example, radio 114 may include at least one transmitter 118, and/or radio 144 may include at least one transmitter 148.

In some demonstrative aspects, radio 114 and/or radio 144, transmitters 118 and/or 148, and/or receivers 116 and/or 146 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like. For example, radio 114 and/or radio 144 may include or may be implemented as part of a wireless Network Interface Card (NIC), and the like.

In some demonstrative aspects, radios 114 and/or 144 may be configured to communicate over a 2.4 GHz band, a 5 GHz band, a 6 GHz band, a mmWave band, and/or any other band, for example, a 5G band, an S1G band, and/or any other band.

In some demonstrative aspects, radios 114 and/or 144 may include, or may be associated with one or more antennas.

In some demonstrative aspects, device 102 may include one or more, e.g., a single antenna or a plurality of, antennas 107, and/or device 140 may include on or more, e.g., a single antenna or-a plurality of, antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. Antennas 107 and/or 147 may include, for example, antennas suitable for directional communication, e.g., using beamforming techniques. For example, antennas 107 and/or 147 may include a single antenna, a plurality of antennas, a phased array antenna, a multiple element antenna, a set of switched beam antennas, and/or the like. In some aspects, antennas 107 and/or 147 may implement transmit and receive functionalities using separate transmit and receive antenna elements. In some aspects, antennas 107 and/or 147 may implement transmit and receive functionalities using common and/or integrated transmit/receive elements.

In some demonstrative aspects, antennas 107 and/or antennas 147 may be connected to, and/or associated with, one or more Radio Frequency (RF) chains.

In some demonstrative aspects, device 102 may include a controller 124, and/or device 140 may include a controller 154. Controller 124 may be configured to perform and/or to trigger, cause, instruct and/or control device 102 to perform, one or more communications, to generate and/or communicate one or more messages and/or transmissions, and/or to perform one or more functionalities, operations and/or procedures between devices 102, 140, 160 and/or one or more other devices; and/or controller 154 may be configured to perform, and/or to trigger, cause, instruct and/or control device 140 to perform, one or more communications, to generate and/or communicate one or more messages and/or transmissions, and/or to perform one or more functionalities, operations and/or procedures between devices 102, 140, 160 and/or one or more other devices, e.g., as described below.

In some demonstrative aspects, controllers 124 and/or 154 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controllers 124 and/or 154, respectively. Additionally or alternatively, one or more functionalities of controllers 124 and/or 154 may be implemented by logic, which may be executed by a machine and/or one or more processors, e.g., as described below.

In one example, controller 124 may include circuitry and/or logic, for example, one or more processors including circuitry and/or logic, to cause, trigger and/or control a wireless device, e.g., device 102, and/or a wireless station, e.g., a wireless STA implemented by device 102, to perform one or more operations, communications and/or functionalities, e.g., as described herein. In one example, controller 124 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In one example, controller 154 may include circuitry and/or logic, for example, one or more processors including circuitry and/or logic, to cause, trigger and/or control a wireless device, e.g., device 140, and/or a wireless station, e.g., a wireless STA implemented by device 140, to perform one or more operations, communications and/or functionalities, e.g., as described herein. In one example, controller 154 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, at least part of the functionality of controller 124 may be implemented as part of one or more elements of radio 114, and/or at least part of the functionality of controller 154 may be implemented as part of one or more elements of radio 144.

In other aspects, the functionality of controller 124 may be implemented as part of any other element of device 102, and/or the functionality of controller 154 may be implemented as part of any other element of device 140.

In some demonstrative aspects, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative aspects, device 140 may include a message processor 158 configured to generate, process and/or access one or messages communicated by device 140.

In one example, message processor 158 may be configured to generate one or more messages to be transmitted by device 140, and/or message processor 158 may be configured to access and/or to process one or more messages received by device 140, e.g., as described below.

In one example, message processor 158 may include at least one first component configured to generate a message, for example, in the form of a frame, field, information element and/or protocol data unit, for example, an MPDU; at least one second component configured to convert the message into a PPDU, for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 158 may be configured to perform any other additional or alternative functionality and/or may include any other additional or alternative components to generate and/or process a message to be transmitted.

In some demonstrative aspects, message processors 128 and/or 158 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, BB circuitry and/or logic, a BB processor, a BB memory, AP circuitry and/or logic, an AP processor, an AP memory, and/or any other circuitry and/or logic, configured to perform the functionality of message processors 128 and/or 158, respectively. Additionally or alternatively, one or more functionalities of message processors 128 and/or 158 may be implemented by logic, which may be executed by a machine and/or one or more processors, e.g., as described below.

In some demonstrative aspects, at least part of the functionality of message processor 128 may be implemented as part of radio 114, and/or at least part of the functionality of message processor 158 may be implemented as part of radio 144.

In some demonstrative aspects, at least part of the functionality of message processor 128 may be implemented as part of controller 124, and/or at least part of the functionality of message processor 158 may be implemented as part of controller 154.

In other aspects, the functionality of message processor 128 may be implemented as part of any other element of device 102, and/or the functionality of message processor 158 may be implemented as part of any other element of device 140.

In some demonstrative aspects, at least part of the functionality of controller 124 and/or message processor 128 may be implemented by an integrated circuit, for example, a chip, e.g., a System on Chip (SoC). In one example, the chip or SoC may be configured to perform one or more functionalities of radio 114. For example, the chip or SoC may include one or more elements of controller 124, one or more elements of message processor 128, and/or one or more elements of radio 114. In one example, controller 124, message processor 128, and radio 114 may be implemented as part of the chip or SoC.

In other aspects, controller 124, message processor 128 and/or radio 114 may be implemented by one or more additional or alternative elements of device 102.

In some demonstrative aspects, at least part of the functionality of controller 154 and/or message processor 158 may be implemented by an integrated circuit, for example, a chip, e.g., a System on Chip (SoC). In one example, the chip or SoC may be configured to perform one or more functionalities of radio 144. For example, the chip or SoC may include one or more elements of controller 154, one or more elements of message processor 158, and/or one or more elements of radio 144. In one example, controller 154, message processor 158, and radio 144 may be implemented as part of the chip or SoC.

In other aspects, controller 154, message processor 158 and/or radio 144 may be implemented by one or more additional or alternative elements of device 140.

In some demonstrative aspects, device 102, device 140, and/or device 160 may include, operate as, perform the role of, and/or perform one or more functionalities of, one or more STAs. For example, device 102 may include at least one STA, device 140 may include at least one STA, and/or device 160 may include at least one STA.

In other aspects, devices 102, 140 and/or 160 may include, operate as, perform the role of, and/or perform one or more functionalities of, any other wireless device and/or station, e.g., a WLAN STA, a Wi-Fi STA, and the like.

In some demonstrative aspects, device 102, device 140, and/or device 160 may be configured operate as, perform the role of, and/or perform one or more functionalities of, an access point (AP).

In some demonstrative aspects, device 102, device 140, and/or device 160 may be configured to operate as, perform the role of, and/or perform one or more functionalities of, a non-AP STA.

In other aspects, device 102, device 140, and/or device 160 may operate as, perform the role of, and/or perform one or more functionalities of, any other additional or alternative device and/or station.

In one example, a station (STA) may include a logical entity that is a singly addressable instance of a medium access control (MAC) and physical layer (PHY) interface to the wireless medium (WM). The STA may perform any other additional or alternative functionality.

In one example, an AP may include an entity that contains a station (STA), e.g., one STA, and provides access to distribution services, via the wireless medium (WM) for associated STAs. The AP may perform any other additional or alternative functionality.

In one example, a non-AP STA may include a STA that is not contained within an AP. The non-AP STA may perform any other additional or alternative functionality.

In some demonstrative aspects, devices 102, 140 and/or 160 may be configured to operate in accordance with one or more Specifications, for example, including one or more IEEE 802.11 Specifications, e.g., an IEEE 802.11-2020 Specification and/or any other specification and/or protocol.

In some demonstrative aspects, device 140 may include, operate as, perform a role of, and/or perform the functionality of, an AP STA.

In some demonstrative aspects, device 102, and/or device 160 may include, operate as, perform a role of, and/or perform the functionality of, one or more non-AP STAs. For example, device 102 may include, operate as, perform a role of, and/or perform the functionality of, at least one non-AP STA, and/or device 160 may include, operate as, perform a role of, and/or perform the functionality of, at least one non-AP STA.

In some demonstrative aspects, device 102, device 140, and/or device 160 may be configured to support, perform, participate in, and/or communicate one or more self-transmissions and/or one or more non-self-transmissions, e.g., as described below.

In some demonstrative aspects, a wireless communication device, e.g., device 102, device 140, and/or device 160, may be configured to perform a self-transmission, which may include a transmission from a transmitter of the wireless communication device to a receiver of the wireless communication device, e.g., as described below.

In some demonstrative aspects, a wireless communication device, e.g., device 102, may be configured to use a receiver of the wireless communication device, e.g., receiver 116, for example, to receive and/or process one or more self-transmissions transmitted by the transmitter of the wireless communication device, e.g., transmitter 118.

For example, device 102 may be configured to perform a self-transmission, which may include, for example, a transmission from transmitter 118 of wireless communication device 102 to receiver 116 of wireless communication device 102, e.g., as described below.

In some demonstrative aspects, a wireless communication device, e.g., device 102, device 140, and/or device 160, may be configured to perform a self-transmission, which may include, for example, one or more Null Data Packets (NDPs), e.g., as described below.

In other aspects, the self-transmission may be configured to include any other additional or alternative types of packets.

In some demonstrative aspects, a wireless communication device, e.g., device 102, device 140, and/or device 160, may be configured to perform a self-transmission, which may be configured for one or more self-transmission-based operations and/or activities (also referred to as “auxiliary activities”), e.g., as described below.

In some demonstrative aspects, a wireless communication device, e.g., device 102, device 140, and/or device 160, may be configured to perform a self-transmission, which may include a proximity sensing transmission, which may be configured for proximity sensing, e.g., as described below.

In some demonstrative aspects, a wireless communication device, e.g., device 102, device 140, and/or device 160, may be configured to perform a self-transmission, which may include, for example, an active proximity sensing transmission, which may be configured for active proximity sensing, e.g., as described below.

In one example, the active proximity sensing may be based on a Tx to Rx (Tx-Rx) loopback, e.g., between a transmitter and a receiver of a wireless communication device, for example, using a first antenna and a second antenna. In one example, the transmitter may send a radio signal from the first antenna, and the receiver may use the second antenna to receive the transmitted radio signal. For example, the radio signal may be reflected from nearby objects and may be monitored over time. This implementation may allow the wireless communication device to detect motion, proximity, and/or presence, for example, of the nearby devices.

In some demonstrative aspects, a wireless communication device, e.g., device 102, device 140, and/or device 160, may be configured to perform a self-transmission, which may include, for example, a channel-sounding transmission, which may be configured for channel-sounding-based measurements, e.g., as described below.

In some demonstrative aspects, a wireless communication device, e.g., device 102, device 140, and/or device 160, may be configured to perform a self-transmission, which may include, for example, a calibration transmission, which may be configured for calibration of one or more elements of the wireless communication device. For example, the self-transmission may be configured for calibration, e.g., an active calibration and/or an active self-measurement, of a transmitter and/or a receiver of the wireless communication device, e.g., as described below.

In one example, the active self-measurement and/or the active calibration may be based, for example, on an internal Tx to Rx post-Power Amplifier (PA) loopback, e.g., between a transmitter and a receiver of a wireless communication device. For example, the transmitter may transmit a modulated signal, and the receiver may capture the modulated signal in a memory, for example, for post processing by one or more algorithms, which may be configured to mitigate radio impairments, e.g., over time and/or temperature.

In some demonstrative aspects, a wireless communication device, e.g., device 102, device 140, and/or device 160, may be configured to perform a self-transmission, which may include, for example, one or more built-in testing transmissions. For example, the built-in testing transmissions may be configured for a built-in test of the wireless communication device, e.g., as described below.

In some demonstrative aspects, a wireless communication device, e.g., device 102, device 140, and/or device 160, may be configured to perform one or more self-transmissions, which may include, for example, one or more auxiliary transmissions, which may be configured for one or more auxiliary operations at the wireless communication device, e.g., as described below.

In some demonstrative aspects, a wireless communication device, e.g., device 102, device 140, and/or device 160, may be configured to perform one or more self-transmissions, which may include, for example, a burst of frames, which may not serve a network activity of the wireless communication device, e.g., as described below.

In some demonstrative aspects, a wireless communication device, e.g., device 102, device 140, and/or device 160, may be configured to perform one or more self-transmissions, which may include, for example, one or more unbounded transmissions, which may be unbounded by transmit limitations applied to non-self transmissions, e.g., as described below.

In some demonstrative aspects, the unbounded transmissions may not be required to, and/or may not be bounded by, WiFi requirements and/or limitations.

In some demonstrative aspects, the unbounded transmissions may include any suitable type of transmissions, for example, radar transmissions, sensing transmissions, calibration transmissions, or the like.

In some demonstrative aspects, a wireless communication device, e.g., device 102, device 140, and/or device 160, may be configured to control one or more parameters, properties and/or attributes of a self-transmission, e.g., a packet of a self-transmission. In one example, the wireless communication device, e.g., device 102, may be configured to control one or more parameters, properties and/or attributes of each packet of a self-transmission, for example, in the form of an unbounded transmission, e.g., as described below.

In some demonstrative aspects, the unbounded transmission may be performed, for example, during an auxiliary activity period.

In some demonstrative aspects, the unbounded transmission may include transmission of a burst of frames, e.g., including frames that do not serve network activity.

In some demonstrative aspects, a wireless communication device, e.g., device 102, device 140, and/or device 160, may be configured to control a duration of a packet in a self-transmission, e.g., an unbounded transmission, a Bandwidth (BW) of the packet in the self-transmission, a format of the packet in the self-transmission, a waveform of the packet in the self-transmission, a Tx power of the packet in the self-transmission, e.g., under regulation limitations, and/or any other additional and/or alternative parameters, properties and/or attributes of the packet in the self-transmission.

In some demonstrative aspects, a wireless communication device, e.g., device 102, may be configured to use a receiver of the wireless communication device, e.g., receiver 116, for example, to receive and/or process the one or more self-transmissions, e.g., of an unbounded transmission activity.

In some demonstrative aspects, a wireless communication device, e.g., device 102, device 140, and/or device 160, may be configured to perform one or more non-self-transmissions, which may include transmissions from a transmitter of the wireless communication device to an other wireless communication device, e.g., as described below.

For example, a STA implemented by device 102 may be configured to perform one or more non-self-transmissions from transmitter 118 of wireless communication device 102 to one or more other STAs, e.g., a STA implemented by wireless communication device 140, e.g., as described below.

In some demonstrative aspects, a wireless communication device, e.g., device 102, device 140, and/or device 160, may be configured to perform one or more non-self-transmissions, which may include one or more MAC frames to be communicated between the wireless communication device and one or more other wireless communication devices, e.g., as described below.

In some demonstrative aspects, a wireless communication device, e.g., device 102, device 140, and/or device 160, may be configured to perform one or more non-self-transmissions, which may include one or more data frames to be communicated between the wireless communication device and one or more other wireless communication devices, e.g., as described below.

In some demonstrative aspects, a STA in a wireless communication network may be required to gain medium access of a wireless medium in order to perform one or more transmissions, e.g., self-transmissions and/or non-self transmissions.

In some demonstrative aspects, the STA may be required to gain medium access to perform one or more self-transmissions, e.g., internal auxiliary activity, for example, on a same channel the STA may be operating with an associated AP, for example, for non-self-transmissions.

In some demonstrative aspects, there may be a need to provide a technical solution, which may support medium access efficiency on a wireless medium, which may be used by a STA for one or more self-transmissions and one or more non-self-transmissions, e.g., as described below.

In some demonstrative aspects, there may be a need to provide a technical solution for scheduling auxiliary activities of a STA, e.g., using one or more self-transmissions, for example, in a way, which may reduce an overhead of the auxiliary activities of the STA on a Wi-Fi network and/or connectivity Key Performance Indicators (KPIs), for example, while maintaining connectivity KPIs of the auxiliary activity. For example, such a scheduling of the auxiliary activities of a STA may provide a technical solution to ensure sufficient overall user experience.

In some demonstrative aspects, for example, in some use cases, scenarios, and/or implementations, there may be one or more disadvantages, inefficiencies, and/or technical problems in implementations using a dedicated Transmit Opportunity (TxOP), which is dedicated to reserve a wireless medium for only self-transmissions, e.g., as described below.

In one example, a STA may reserve a wireless communication medium for one or more self-transmissions using a dedicated TxOP, e.g., in a similar manner to reserving the wireless communication medium for non-self-transmissions. For example, the STA may initiate and transmit a Clear To Send (CTS) to Self (CTS-to-Self) frame, for example, as a Network Allocation Vector (NAV) distribution mechanism to reserve the medium for a reserved time period, during which the STA is to transmit one or more self-transmissions. For example, the STA may transmit self-transmissions, for example, in the form of a burst of Tx packets with a Short Inter-Frame Space (SIFS) apart, e.g., after the CTS-to-Self frame. For example, the STA may define a duration value in the CTS-to-Self frame to define the reserved time period to cover a burst length, which may be defined as needed, e.g., for a specific use case. For example, during the reserved time period, a receiver of the STA may be busy with processing the self-transmissions and may not able to receive Wi-Fi network traffic, e.g., from an associated AP.

In one example, implementing the dedicated TxOP for the self-transmissions may increase overhead on a wireless network, which, in turn, may impact a user experience and/or one or more network and/or connectivity KPIs.

In one example, implementing the dedicated TxOP for the self-transmissions may reduce station throughput of the STA and/or may cause higher latency jitter, for example, over a wireless network, e.g., a WiFi network.

In another example, implementing the dedicated TxOP for the self-transmissions may not be efficient. For example, implementing the dedicated TxOP for the self-transmission may impact network efficiency and/or a medium load, and/or it may be hard for the STA to “re-gain” medium access.

In another example, an implementation using the dedicated TxOP for the self-transmissions may not be scalable. For example, the wireless medium may be blocked, for example, if multiple stations use dedicated TxOPs for self-transmissions.

In some demonstrative aspects, devices 102, 140, and/or 160 may be configured to implement a TxOP scheduling mechanism, which may be configured, for example, to support self-transmissions, e.g., as described below.

In some demonstrative aspects, devices 102, 140, and/or 160 may be configured to implement a combined TxOP, for example, to support self-transmissions, e.g., as described below.

In some demonstrative aspects, the combined TxOP may be configured to support a combination of one or more first periods for communication of one or more self-transmissions, and one or more second periods for communication of non-self-transmissions, e.g., as described below.

In some demonstrative aspects, the combined TxOP may provide a technical solution, which may reduce overhead of auxiliary activities, for example, on a wireless network and/or connectivity KPIs, e.g., as described below.

In some demonstrative aspects, the combined TxOP may be configured based on existing capabilities of one or more protocols, e.g., in compliance with the IEEE 802.11 Standards. For example, the combined TxOP may be configured to provide a technical solution, which may leverage existing or planed Tx opportunities, for example, to include both non-self-transmissions, e.g., of data-path activities, as well as self-transmissions, e.g., of auxiliary activities.

In some demonstrative aspects, the combined TxOP may be scheduled based on a combined TxOP approach, which may schedule a first time allocation and a second time allocation in a same “combined” TxOP. For example, the first time allocation may be scheduled based on a time required for non-self-transmissions, e.g., of the data transfers. For example, the second time allocation may be scheduled based on a time, e.g., a short time allocation, which may be required for self-transmissions, e.g., of the auxiliary activities, as described below.

In some demonstrative aspects, the second time allocation, which is scheduled for the self-transmissions, e.g., of the auxiliary activities, may be before or after the first time allocation, which is scheduled for the non-self-transmissions, e.g., of the data transfers, as described below.

In some demonstrative aspects, the combined TxOP may be configured to include more than one first time allocation, which is scheduled for the non-self-transmissions, and/or more than one second time allocation, which is scheduled for the self-transmissions, e.g., as described below.

In some demonstrative aspects, the combined TxOP may be initiated by a STA or an AP, for example, based on a fact that a STA or AP that obtains a TxOP may be allowed to transmit one or more transmissions over the wireless medium during the obtained TxOP, e.g., as a single transmission or as a burst of back-to-back frames.

In some demonstrative aspects, the combined TxOP may be implemented to provide a technical solution, which may reduce an overall overhead and impact of the auxiliary activities on a wireless network.

In some demonstrative aspects, the combined TxOP may be implemented to provide a technical solution, which may improve an overall user experience and KPIs. For example, the combined TxOP may be implemented to allow additional services, which may require medium access, e.g., active proximity sensing, vital sign monitoring, and/or the like.

In some demonstrative aspects, controller 124 may be configured to control, cause and/or trigger a STA implemented by device 102 to transmit a reservation frame to reserve wireless communication medium 103 for a TxOP, e.g., as described below.

In some demonstrative aspects, the TxOP may be configured to cover a first reserved duration and a second reserved duration, e.g., as described below.

In some demonstrative aspects, the first reserved duration may be configured for at least one self-transmission of the STA implemented by device 102, e.g., as described below.

In some demonstrative aspects, the second reserved duration may be configured for communication of at least one non-self-transmission by the STA implemented by device 102, e.g., as described below.

In some demonstrative aspects, controller 124 may be configured to control, cause and/or trigger the STA implemented by device 102 to transmit the at least one self-transmission during the first duration, e.g., as described below.

In some demonstrative aspects, the self-transmission may be configured for transmission from transmitter 118 of the STA implemented by device 102 to receiver 116 of the STA implemented by device 102, e.g., as described below.

In some demonstrative aspects, controller 124 may be configured to control, cause and/or trigger the STA implemented by device 102 to communicate the at least one non-self-transmission with an other STA, e.g., a STA implemented by device 140, during the second reserved duration, e.g., as described below.

In some demonstrative aspects, the at least one non-self-transmission may include a non-self transmitted frame transmitted from transmitter 118 of the STA implemented by device 102 to the other STA, and/or a non-self received frame received from the other STA at the receiver 116 of the STA implemented by device 102, e.g., as described below.

In some demonstrative aspects, the non-self-transmission may include at least one non-self MAC frame, which may be communicated between the STA implemented by device 102 and the other STA, for example, device 140, e.g., as described below.

In some demonstrative aspects, controller 124 may be configured to control, cause and/or trigger the STA implemented by device 102 to determine a duration of the TxOP, for example, based on a duration of the at least one self-transmission of the STA implemented by device 102 and the at least one non-self-transmission by the STA implemented by device 102, e.g., as described below.

In some demonstrative aspects, controller 124 may be configured to control, cause and/or trigger the STA implemented by device 102 to set a duration field in the reservation frame to indicate the duration of the TxOP, e.g., as described below.

In some demonstrative aspects, the second reserved duration may be equal to or longer than a duration of a MAC frame, e.g., as described below.

In some demonstrative aspects, the first reserved duration may be after the second reserved duration, e.g., as described below.

In some demonstrative aspects, the first reserved duration may be before the second reserved duration, e.g., as described below.

In some demonstrative aspects, the TxOP may be configured to cover a plurality of reserved durations configured for a plurality of self transmissions, e.g., as described below.

In some demonstrative aspects, two reserved durations configured for self-transmissions may be, for example, separated by a one or more reserved durations configured for non-self transmissions, e.g., as described below.

In some demonstrative aspects, the first reserved duration may be configured for at least one first self-transmission of the STA implemented by device 102, e.g., as described below.

In some demonstrative aspects, the second reserved duration may be after the first reserved duration, e.g., as described below.

In some demonstrative aspects, the second reserved duration may be configured for communication of at least one non-self-transmission by the STA implemented by device 102, e.g., as described below.

In some demonstrative aspects, the TxOP may be configured to cover a third reserved duration after the second reserved duration, e.g., as described below.

In some demonstrative aspects, the third reserved duration may be configured for at least one second self-transmission of the STA implemented by device 102, e.g., as described below.

In other aspects, the TxOP may be configured to include any other count of reserved durations for self-transmissions, any other count of reserved durations for non-self-transmissions, and/or any other order of the reserved durations for self-transmission and/or the reserved durations for non-self-transmissions.

In some demonstrative aspects, the reservation frame may include a reservation frame from a non-AP STA, e.g., implemented by device 102, to an AP STA, e.g., implemented by device 140, e.g., as described below.

In some demonstrative aspects, the at least one non-self-transmission may include an Uplink (UL) frame from the non-AP STA to the AP STA, e.g., from the non-AP STA implemented by device 102 to the AP implemented by device 140, and an Acknowledgement (ACK) from the AP STA to the non-AP STA, for example, from the AP implemented by device 140 to the non-AP STA implemented by device 102, e.g., as described below.

In some demonstrative aspects, the reservation frame may include a Request to Send (RTS), e.g., as described below.

In other aspects, the reservation frame may include any other additional or alternative type of frame.

In some demonstrative aspects, controller 124 may be configured to control, cause and/or trigger the STA implemented by device 102 to initiate the TxOP, for example, based on receipt of a Clear to Send (CTS) in response to the RTS, e.g., as described below.

In some demonstrative aspects, the at least one self-transmission of the STA implemented by device 102 may include a burst of frames, e.g., as described below.

In some demonstrative aspects, the at least one self-transmission of the STA implemented by device 102 may include a Null Data Packet (NDP), e.g., as described below.

In some demonstrative aspects, the at least one self-transmission of the STA implemented by device 102 may include an unbounded transmission, which may be unbounded by transmit limitations applied to the at least one non-self-transmission, e.g., as described below.

In some demonstrative aspects, the at least one self-transmission of the STA implemented by device 102 may include a self-measurement transmission, which may be configured for a self-measurement at the STA implemented by device 102, for example, based on reception of the self-transmission at the receiver 116 of the STA implemented by device 102, e.g., as described below.

In some demonstrative aspects, the at least one self-transmission of the STA implemented by device 102 may include a proximity sensing transmission configured for proximity sensing at the STA implemented by device 102, for example, based on reception of the self-transmission at the receiver 116 of the STA implemented by device 102, e.g., as described below.

In some demonstrative aspects, the at least one self-transmission of the STA implemented by device 102 may include a channel-sounding transmission configured for a channel-sounding-based measurement at the STA implemented by device 102, for example, based on reception of the self-transmission at the receiver 116 of the STA implemented by device 102, e.g., as described below.

In some demonstrative aspects, the at least one self-transmission of the STA implemented by device 102 may include a calibration transmission configured for calibration of the transmitter 118 of the STA implemented by device 102 or the receiver 116 of the STA implemented by device 102, e.g., as described below.

In some demonstrative aspects, the at least one self-transmission of the STA implemented by device 102 may include a built-in testing transmission configured for a built-in test at the STA implemented by device 102, e.g., as described below.

In some demonstrative aspects, the at least one self-transmission of the STA implemented by device 102 may include an auxiliary transmission configured for one or more auxiliary operations at the STA implemented by device 102, for example, based on reception of the auxiliary transmission at the receiver of the STA implemented by device 102, e.g., as described below.

In some demonstrative aspects, a combined TxOP may be reserved by a non-AP STA, e.g., the non-AP STA implemented by device 102, to reserve the wireless communication medium for at least a first duration for self-transmissions of the non-AP STA and a second duration for non-self-transmissions of the non-AP STA, e.g., as described above.

In some demonstrative aspects, a combined TxOP may be reserved by an AP STA, e.g., an AP STA implemented by device 140, to reserve the wireless communication medium for at least a first duration for self-transmissions of the AP STA and a second duration for non-self-transmissions of the AP STA, e.g., in a similar manner to the combined TxOP for the non-AP STA described above.

In some demonstrative aspects, the TxOP to reserve wireless communication medium 103 may be triggered by an AP, for example, by an AP implemented by device 140, e.g., as described below.

In some demonstrative aspects, a non-AP STA, e.g., a non-AP STA implemented by device 102, may request the AP to trigger the TxOP, e.g., as described below.

In some demonstrative aspects, controller 124 may be configured to control, cause and/or trigger the non-AP STA implemented by device 102 to request a time allocation from an AP STA, for example, the AP implemented by device 140, e.g., as described below.

In some demonstrative aspects, the time allocation may be configured to cover a first reserved duration and a second reserved duration, e.g., as described below.

In some demonstrative aspects, the first reserved duration may be configured for at least one self-transmission of the non-AP STA implemented by device 102, e.g., as described below.

In some demonstrative aspects, the second reserved duration may be configured for communication of at least one non-self-transmission by the non-AP STA implemented by device 102, e.g., as described below.

In some demonstrative aspects, controller 124 may be configured to control, cause and/or trigger the non-AP STA implemented by device 102 to process a reservation frame from the AP STA, e.g., as described below.

In some demonstrative aspects, the reservation frame may be configured to reserve the wireless communication medium 103 for a TxOP, for example, based on the time allocation requested by the non-AP STA implemented by device 102, e.g., as described below.

In some demonstrative aspects, the reservation frame may include an RTS, e.g., as described below.

In other aspects, the reservation frame may include any other additional or alternative type of frame.

In some demonstrative aspects, controller 124 may be configured to control, cause and/or trigger the non-AP STA implemented by device 102 to transmit a CTS in response to the RTS, e.g., as described below.

In some demonstrative aspects, controller 124 may be configured to control, cause and/or trigger the non-AP STA implemented by device 102 to transmit the at least one self-transmission during the first duration, e.g., as described below.

In some demonstrative aspects, controller 124 may be configured to control, cause and/or trigger the non-AP STA implemented by device 102 to communicate the at least one non-self-transmission during the second reserved duration, e.g., as described below.

In some demonstrative aspects, the at least one non-self-transmission may include a triggered Peer to Peer (P2P) transmission between the non-AP STA implemented by device 102, and another non-AP STA, for example, a non-AP STA implemented by device 160, e.g., as described below.

In some demonstrative aspects, the at least one non-self-transmission may include an UL triggered P2P transmission from the non-AP STA to the other non-AP STA. For example, the at least one non-self-transmission may include an UL triggered P2P transmission from the non-AP STA implemented by device 102 to the non-AP STA implemented by device 160.

In some demonstrative aspects, the at least one non-self-transmission may include a DL triggered P2P transmission from the other non-AP STA to the non-AP STA implemented by device 102. For example, the at least one non-self-transmission may include a DL triggered P2P transmission from the non-AP STA implemented by device 160 to the non-AP STA implemented by device 102.

In some demonstrative aspects, controller 124 may be configured to control, cause and/or trigger the non-AP STA implemented by device 102 to determine a duration of the time allocation requested by the non-AP STA implemented by device 102, for example, based on a duration of the at least one self-transmission of the non-AP STA implemented by device 102 and the at least one non-self-transmission by the non-AP STA implemented by device 102, e.g., as described below.

In some demonstrative aspects, controller 124 may be configured to control, cause and/or trigger the non-AP STA implemented by device 102 to initiate the first reserved duration, for example, based on a first trigger frame from the AP STA, for example, from the AP implemented by device 140, e.g., as described below.

In some demonstrative aspects, controller 124 may be configured to control, cause and/or trigger the non-AP STA implemented by device 102 to initiate the second reserved duration, for example, based on a second trigger frame from the AP STA, for example, from the AP implemented by device 140, e.g., as described below.

In some demonstrative aspects, a combined TxOP may be configured to include at least one reserved period for self-transmissions, and at least one reserved period for non-self-transmissions, e.g., as described above.

In some demonstrative aspects, the combined TxOP may be implemented to provide a technical solution to reduce overhead over a wireless communication network, e.g., as described below.

In one example, a wireless communication network may have the following attributes:
Network includes 10 stations
Each station requires 50 auxiliary activities per second
Average TxOP overhead ˜81 microseconds (us)
CTS to self period=40 us
2 slots=18 us
Average random backoff for Access Category Video (AC_VI)=23 us

According to this example, the combined TxOP may be implemented to provide a duration of a network medium load saving per second of about 40.5 ms, e.g., 10×50×81 us=40.5 ms. This may provide a saving of about 4% of the network medium load, for example, compared to a network medium load of a dedicated TxOP, which is dedicated only to self-transmissions.

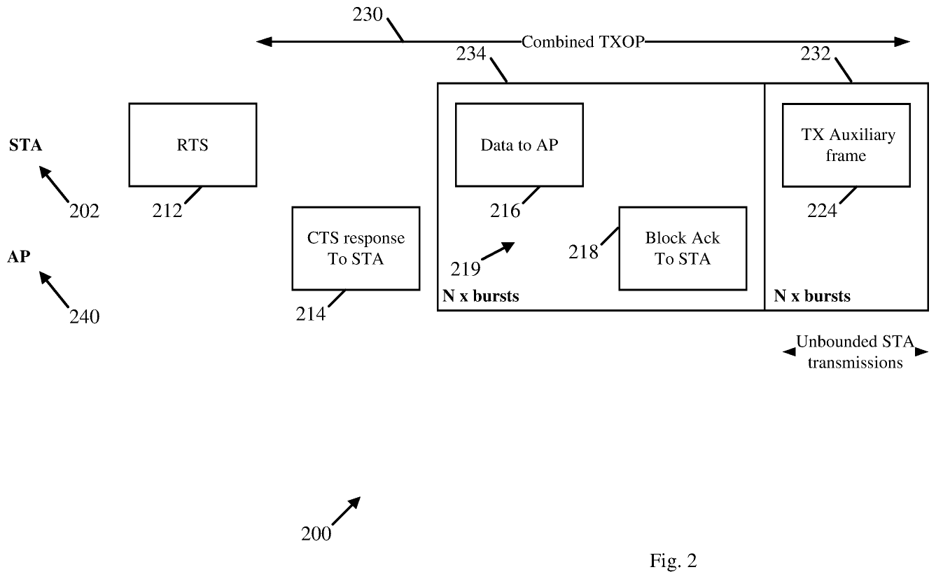

Reference is made to FIG. 2, which schematically illustrates a communication scheme 200 including communications performed by a STA 202 and an AP 240, in accordance with some demonstrative aspects. For example, device 102 (FIG. 1) may include STA 202, and/or may perform one or more operations and/or functionalities of STA 202; and/or device 140 (FIG. 1) may include AP 240, and/or may perform one or more operations and/or functionalities of AP 240.

In one example, controller 124 (FIG. 1) may be configured to control, cause and/or trigger the STA implemented by device 102 (FIG. 1) to perform one or more operations of STA 202 according to communication scheme 200, for example, to transmit one or more self-transmissions during a TxOP.

In some demonstrative aspects, as shown in FIG. 2, STA 202 may transmit an RTS frame 212 to reserve a wireless communication medium for a TxOP 230, e.g., a combined TxOP.

In some demonstrative aspects, as shown in FIG. 2, TxOP 230 may be initiated by the STA 202, for example, by transmission of RTS 212.

In some demonstrative aspects, as shown in FIG. 2, the STA 202 may initiate the TxOP 230, for example, based on receipt of a Clear to Send (CTS) frame 214, e.g., in response to the RTS frame 212.

In some demonstrative aspects, as shown in FIG. 2, the TxOP 230 may cover a first reserved duration 232, and a second reserved duration 234.

In some demonstrative aspects, as shown in FIG. 2, the first reserved duration 232 may be after the second reserved duration 234.

In other aspects, the first reserved duration 232 may be before the second reserved duration 234.

In some demonstrative aspects, as shown in FIG. 2, the first reserved duration 232 may be configured for a self-transmission 224, e.g., including at least one Tx auxiliary frame, of the STA 202.

In some demonstrative aspects, as shown in FIG. 2, self-transmission 224 may include a burst of frames, e.g., including N bursts.

In some demonstrative aspects, as shown in FIG. 2, the STA 202 may transmit the self-transmission 224, for example, during the first reserved duration 232.

In some demonstrative aspects, as shown in FIG. 2, the second reserved duration 234 may be configured for communication of non-self-transmissions 219 by the STA 202.

In some demonstrative aspects, as shown in FIG. 2, the STA 202 may communicate the non-self-transmissions 219 with the AP 240, for example, during the second reserved duration 234.

In some demonstrative aspects, as shown in FIG. 2, non-self-transmissions 219 may include a burst of frames, e.g., including N bursts.

In some demonstrative aspects, as shown in FIG. 2, non-self-transmissions 219 may include, for example, an Uplink (UL) frame 216, e.g., a data frame, which may be transmitted from STA 202 to the AP 240.

In some demonstrative aspects, as shown in FIG. 2, non-self-transmissions 219 may include a Downlink (DL) frame, for example, an Acknowledgement (ACK) frame 218, e.g., a Block ACK (BA) frame, which may be transmitted from the AP 240 to the STA 202, e.g., to acknowledge the UL frame 216.

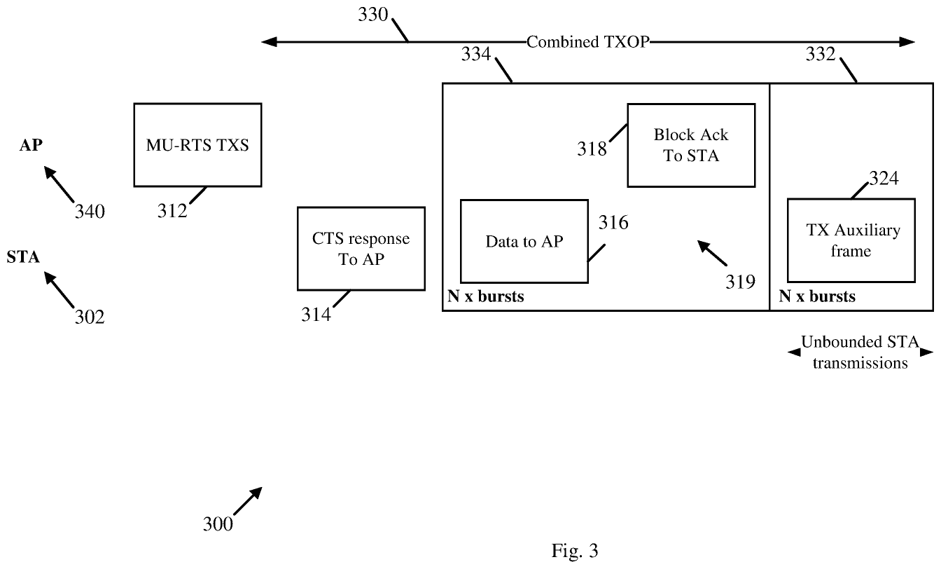

Reference is made to FIG. 3, which schematically illustrates a communication scheme 300 including communications performed by a STA 302 and an AP 340, in accordance with some demonstrative aspects. For example, device 102 (FIG. 1) may include STA 302, and/or may perform one or more operations and/or functionalities of STA 302; and/or device 140 (FIG. 1) may include AP 340, and/or may perform one or more operations and/or functionalities of AP 340.

In one example, controller 124 (FIG. 1) may be configured to control, cause and/or trigger the STA implemented by device 102 (FIG. 1) to perform one or more operations of STA 302 according to communication scheme 300, for example, to transmit one or more self-transmissions during a TxOP.

In some demonstrative aspects, as shown in FIG. 3, STA 302 may process an RTS frame 312, e.g., a Multi-User (MU) RTS, to reserve a wireless communication medium for a TxOP 330, e.g., a combined TxOP.

In some demonstrative aspects, TxOP 330 may be based, for example, on a time allocation requested by the STA 302 from the AP 340.

In some demonstrative aspects, as shown in FIG. 3, TxOP 330 may be initiated and/or triggered by the AP 340, for example, by transmission of MU RTS frame 312.

In some demonstrative aspects, as shown in FIG. 3, the STA 302 may transmit a CTS frame 314, e.g., in response to the RTS frame 312.

In some demonstrative aspects, as shown in FIG. 3, the time allocation in TxOP 330 may be configured to cover a first reserved duration 332, and a second reserved duration 334.

In some demonstrative aspects, as shown in FIG. 3, the first reserved duration 332 may be after the second reserved duration 334.

In other aspects, the first reserved duration 332 may be before the second reserved duration 334.

In some demonstrative aspects, as shown in FIG. 3, the first reserved duration 332 may be configured for a self-transmission 324, e.g., including at least one Tx auxiliary frame, of the STA 302.

In some demonstrative aspects, as shown in FIG. 3, self-transmission 324 may include a burst of frames, e.g., including N bursts.

In some demonstrative aspects, as shown in FIG. 3, the STA 302 may transmit the self-transmission 324, for example, during the first reserved duration 332.

In some demonstrative aspects, as shown in FIG. 3, the second reserved duration 334 may be configured for communication of non-self-transmissions 319 by the STA 302.

In some demonstrative aspects, as shown in FIG. 3, non-self-transmissions 319 may include a burst of frames, e.g., including N bursts.

In some demonstrative aspects, as shown in FIG. 3, the STA 302 may communicate the non-self-transmissions 319 with the AP 340, for example, during the second reserved duration 334.

In some demonstrative aspects, as shown in FIG. 3, non-self-transmissions 319 may include an UL frame 316, e.g., a data frame, which may be transmitted from STA 302 to the AP 340.

In some demonstrative aspects, as shown in FIG. 3, non-self-transmissions 319 may include an ACK frame 318, e.g., a BA frame, which may be transmitted from the AP 340 to the STA 302, e.g., to acknowledge the UL frame 316.

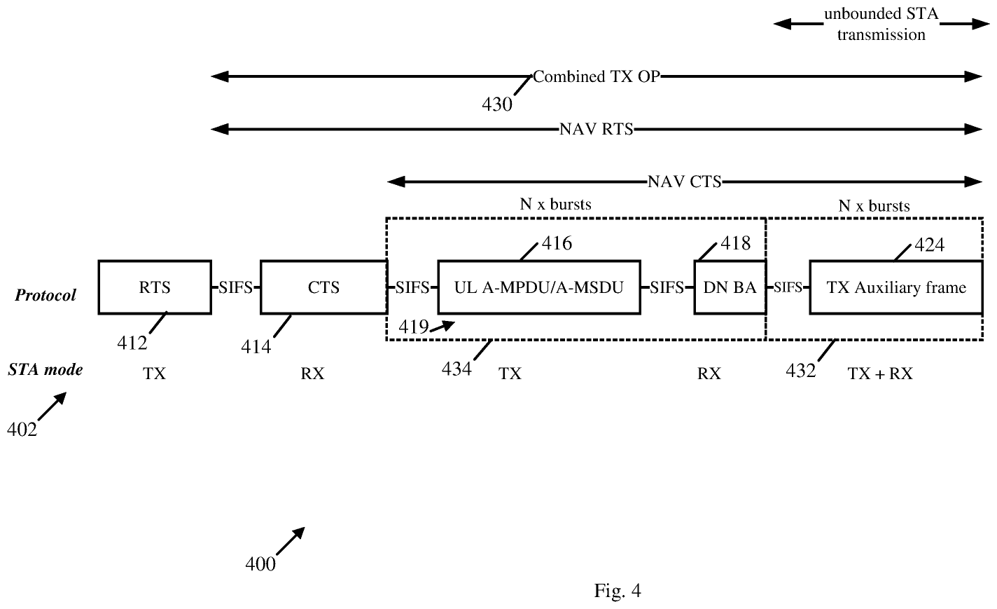

Reference is made to FIG. 4, which schematically illustrates a communication scheme 400 including communications performed by a STA 402 and an AP, in accordance with some demonstrative aspects. For example, device 102 (FIG. 1) may include STA 402, and/or may perform one or more operations and/or functionalities of STA 402; and/or device 140 (FIG. 1) may include the AP, and/or may perform one or more operations and/or functionalities of the AP.

In one example, controller 124 (FIG. 1) may be configured to control, cause and/or trigger the STA implemented by device 102 (FIG. 1) to perform one or more operations of STA 402 according to communication scheme 400, for example, to transmit one or more self-transmissions during a TxOP.

In some demonstrative aspects, STA 402 may be configured to reserve a wireless communication medium for a TxOP 430, e.g., a combined TxOP 430, as described below.

In one example, the STA 402 may initiate the TxOP 430, for example, according to one or more suitable Clear Channel Assessment (CCA) rules and/or Enhanced Distributed Channel Access (EDCA) rules, for example, once the wireless communication medium is free.

In some demonstrative aspects, as shown in FIG. 4, STA 402 may transmit an RTS frame 412 to reserve the wireless communication medium for the TxOP 430, e.g., the combined TxOP 430.

In some demonstrative aspects, as shown in FIG. 4, TxOP 430 may be initiated by the STA 402, for example, by transmission of RTS 412.

In some demonstrative aspects, as shown in FIG. 4, the STA 402 may initiate the TxOP 430, for example, based on receipt of a CTS frame 414, e.g., in response to the RTS frame 412.

In some demonstrative aspects, as shown in FIG. 4, communication scheme 400 may include an RTS/CTS protection mechanism, e.g., including exchanging of RTS frame 412 and CTS frame 414 between STA 402 and AP 440, for example, to reserve a total duration required for TxOP 430.

In other aspects, the TxOP 430 may be reserved according to any other additional or alternative protection mechanism, e.g., using any other additional or alternative type of reservation frames.

In some demonstrative aspects, as shown in FIG. 4, the TxOP 430 may cover a first reserved duration 432, and a second reserved duration 434.

In some demonstrative aspects, as shown in FIG. 4, the first reserved duration 432 may be after the second reserved duration 434.

In other aspects, the first reserved duration 432 may be before the second reserved duration 434.

In some demonstrative aspects, as shown in FIG. 4, the first reserved duration 432 may be configured for a self-transmission 424, e.g., including at least one Tx auxiliary frame, of the STA 402.

In some demonstrative aspects, as shown in FIG. 4, self-transmission 424 may include a burst of frames, e.g., including N bursts.

In some demonstrative aspects, as shown in FIG. 4, the STA 402 may transmit the self-transmission 424, for example, during the first reserved duration 432.

In some demonstrative aspects, as shown in FIG. 4, the second reserved duration 434 may be configured for communication of non-self-transmissions 419 by the STA 402.

In some demonstrative aspects, as shown in FIG. 4, non-self-transmissions 419 may include a burst of frames, e.g., including N bursts.

In some demonstrative aspects, as shown in FIG. 4, the STA 402 may communicate the non-self-transmissions 419 with the AP 440, for example, during the second reserved duration 434.

In some demonstrative aspects, as shown in FIG. 4, non-self-transmissions 419 may include, for example, an UL frame 416, which may be transmitted from STA 402 to the AP 440.

In some demonstrative aspects, as shown in FIG. 4, UL frame 416 may include an UL Aggregate MAC Protocol Data Unit (A-MPDU), or an UL Aggregate MAC Service Data Unit (A-MSDU).

In other aspects, UL frame 416 may include any other additional and/or alternative type of frame.

In some demonstrative aspects, as shown in FIG. 4, non-self-transmissions 419 may include, for example, a DL transmission, e.g., an ACK frame 418, e.g., a Downlink (DN) BA frame, which may be transmitted from the AP 440 to the STA 402, e.g., to acknowledge the UL frame 416.

In some demonstrative aspects, as shown in FIG. 4, the STA 402 may transmit the non-self-transmissions 419, for example, a burst of uplink aggregations, e.g., including A-MPDUs and/or A-MSDUs, which may be responded by an immediate downlink BA, e.g., the DN BA 418, for example, after the RTS/CTS frames.

In some demonstrative aspects, as shown in FIG. 4, the STA 402 may use a reminder allocation of the TxOP 430, e.g., the reserved period 432, after the DN BA 418, for example, for auxiliary activities, for example, for transmission of the self-transmission 424, e.g., including the burst of self-transmitted frames.

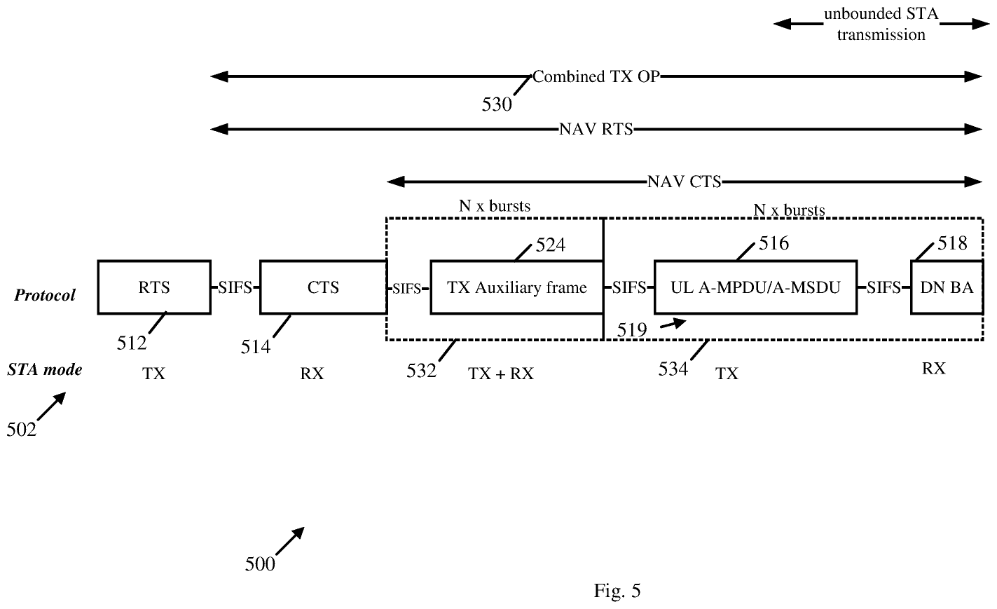

Reference is made to FIG. 5, which schematically illustrates a communication scheme 500 including communications performed by a STA 502 and an AP, in accordance with some demonstrative aspects. For example, device 102 (FIG. 1) may include STA 502, and/or may perform one or more operations and/or functionalities of STA 502; and/or device 140 (FIG. 1) may include the AP, and/or may perform one or more operations and/or functionalities of the AP.

In one example, controller 124 (FIG. 1) may be configured to control, cause and/or trigger the STA implemented by device 102 (FIG. 1) to perform one or more operations of STA 502 according to communication scheme 500, for example, to transmit one or more self-transmissions during a TxOP.

In some demonstrative aspects, STA 502 may be configured to reserve a wireless communication medium for a TxOP 530, e.g., a combined TxOP 530, as described below.

In one example, the STA 502 may initiate the TxOP 530, for example, according to CCA rules and/or EDCA rules, for example, once the wireless communication medium is free.

In some demonstrative aspects, as shown in FIG. 5, STA 502 may transmit an RTS frame 512 to reserve the wireless communication medium for the TxOP 530, e.g., a combined TxOP 530.

In some demonstrative aspects, as shown in FIG. 5, TxOP 530 may be initiated by the STA 502, for example, by transmission of RTS 512.

In some demonstrative aspects, as shown in FIG. 5, the STA 502 may initiate the TxOP 530, for example, based on receipt of a CTS frame 514, e.g., in response to the RTS frame 512.

In some demonstrative aspects, as shown in FIG. 5, communication scheme 500 may include an RTS/CTS protection mechanism, e.g., including the exchanging of RTS frame 512 and CTS frame 514 between STA 502 and AP 540, for example, to reserve a total duration required for TxOP 530.

In other aspects, the TxOP 530 may be reserved according to any other additional or alternative protection mechanism, e.g., using any other additional or alternative type of reservation frames.

In some demonstrative aspects, as shown in FIG. 5, the TxOP 530 may cover a first reserved duration 532, and a second reserved duration 534.

In some demonstrative aspects, as shown in FIG. 5, the first reserved duration 532 may be before the second reserved duration 534.

In other aspects, the first reserved duration 532 may be after the second reserved duration 534.

In some demonstrative aspects, as shown in FIG. 5, the first reserved duration 532 may be configured for a self-transmission 524, e.g., including at least one Tx auxiliary frame, of the STA 502.

In some demonstrative aspects, as shown in FIG. 5, self-transmission 524 may include a burst of frames, e.g., including N bursts.

In some demonstrative aspects, as shown in FIG. 5, the STA 502 may transmit the self-transmission 524, for example, during the first reserved duration 532.

In some demonstrative aspects, as shown in FIG. 5, the STA 502 may transmit the self-transmission 524, e.g., the burst of frames, for example, after the exchange of the RTS/CTS frames.

In some demonstrative aspects, as shown in FIG. 5, the second reserved duration 534 may be configured for communication of non-self-transmissions 519 by the STA 502.

In some demonstrative aspects, as shown in FIG. 5, non-self-transmissions 519 may include a burst of frames, e.g., including N bursts.

In some demonstrative aspects, as shown in FIG. 5, the STA 502 may communicate the non-self-transmissions 519 with the AP 540, for example, during the second reserved duration 534.

In some demonstrative aspects, as shown in FIG. 5, non-self-transmissions 519 may include an UL frame 516, e.g., an A-MPDU, an A-MSDU and/or any other frame, from STA 502 to the AP 540.

In some demonstrative aspects, as shown in FIG. 5, non-self-transmissions 519 may include, for example, a DL transmission, e.g., an ACK frame 518, e.g., a DN BA frame, which may be transmitted from the AP 540 to the STA 502, e.g., to acknowledge the UL frame 516.

In some demonstrative aspects, as shown in FIG. 5, the STA 502 may transmit the non-self-transmissions 519, for example, a burst of uplink aggregations, e.g., the A-MPDU or the A-MSDU, which may be responded by an immediate downlink BA, e.g., the DN BA 518, for example, during a remainder allocation of the TxOP 530, e.g., after the self-transmission 524.

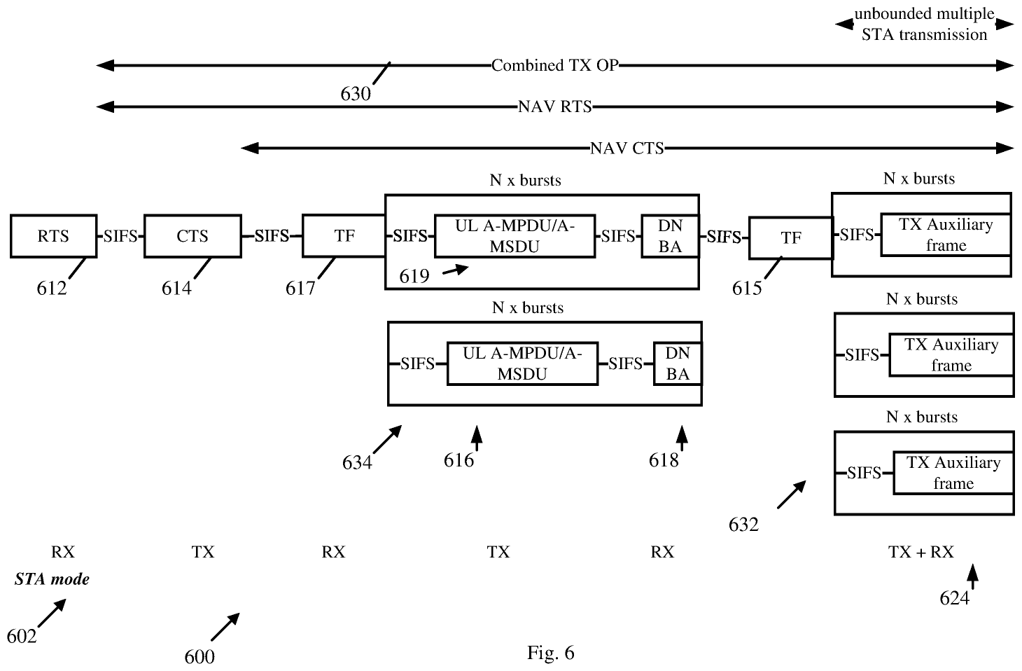

Reference is made to FIG. 6, which schematically illustrates a communication scheme 600 including communications performed by an AP and a plurality of STAs 602, in accordance with some demonstrative aspects. For example, device 102 (FIG. 1) may include a STA 602, and/or may perform one or more operations and/or functionalities of the STA 602; and/or device 140 (FIG. 1) may include the AP, and/or may perform one or more operations and/or functionalities of AP.

In one example, controller 124 (FIG. 1) may be configured to control, cause and/or trigger the STA implemented by device 102 (FIG. 1) to perform one or more operations of a STA 602 according to communication scheme 600, for example, to transmit one or more self-transmissions during a TxOP.

In some demonstrative aspects, as shown in FIG. 6, a TxOP 630 may be initiated and/or triggered by the AP.

In some demonstrative aspects, the AP may determine a duration and/or a timing of the TxOP 630, for example, based on one or more time allocation requests from the one or more STAs 602, e.g., as described below.

In some demonstrative aspects, the one or more stations 602 may negotiate with the AP, for example, to request a required time allocation range, e.g., in the form of a (min, max) capability for one or more requested TxOPs.

In some demonstrative aspects, some of the requested TxOPs may be combined into a combined TxOP, e.g., TxOP 630, for example, according to needs of the one or more stations 602.

In one example, the AP may be configured to find a most suitable time, for example, to schedule the multiple stations 602 to perform their auxiliary transmissions, for example, simultaneously, e.g., during TxOP 630.

In some demonstrative aspects, as shown in FIG. 6, communication scheme 600 may include an RTS/CTS protection mechanism, e.g., including an exchange of RTS and CTS frames between the AP and the STAs 602, for example, to reserve a total duration required for TxOP 630.

In other aspects, the TxOP 630 may be reserved according to any other additional or alternative protection mechanism, e.g., using any other additional or alternative type of reservation frames.

In some demonstrative aspects, as shown in FIG. 6, the AP may transmit an RTS frame 612, which may be configured to reserve a wireless communication medium for the TxOP 630, for example, based on the one or more time allocation requests, which may be requested by one or more of the plurality of STAs 602 from the AP.

In some demonstrative aspects, as shown in FIG. 6, a STA 602 may process the RTS frame 612 from the AP, and may transmit a CTS frame 614, e.g., in response to the RTS frame 612.

In some demonstrative aspects, as shown in FIG. 6, the TxOP 630 may be configured to cover a first reserved duration 632, and a second reserved duration 634.

In some demonstrative aspects, as shown in FIG. 6, the first reserved duration 632 may be after the second reserved duration 634.

In other aspects, the first reserved duration 632 may be before the second reserved duration 634.

In some demonstrative aspects, as shown in FIG. 6, the first reserved duration 632 may be configured for self-transmissions 624, e.g., including Tx auxiliary frames, from the one or more STAs 602.

In some demonstrative aspects, as shown in FIG. 6, the first reserved duration 632 may be initiated, for example, based on a first trigger frame 615 from the AP to the plurality of STAs 602.

In some demonstrative aspects, as shown in FIG. 6, the AP may transmit the trigger frame 615 to indicate a start and/or a duration of the first reserved duration 632, which may be allocated for the self-transmissions 624, e.g., for multi stations auxiliary activity.

In some demonstrative aspects, as shown in FIG. 6, a self-transmission 624 may include a burst of frames, e.g., including N bursts.

In some demonstrative aspects, as shown in FIG. 6, the STA 602 may transmit the self-transmission 624, for example, during the first reserved duration 632.

In some demonstrative aspects, as shown in FIG. 6, the second reserved duration 634 may be configured for communication of non-self-transmissions 619 by the one or more STAs 602.

In some demonstrative aspects, as shown in FIG. 6, a non-self-transmission 619 may include a burst of frames, e.g., including N bursts.

In some demonstrative aspects, as shown in FIG. 6, the STA 602 may communicate the non-self-transmission 619 with the AP, for example, during the second reserved duration 634.

In some demonstrative aspects, as shown in FIG. 6, the non-self-transmission 619 may include, for example, an UL frame 616, e.g., a data frame, which may be transmitted from a STA 602 to the AP.

In some demonstrative aspects, as shown in FIG. 6, the non-self-transmission 619 may include, for example, a DL transmission, an ACK frame 618, e.g., a DN BA frame, which may be transmitted from the AP to the STA 602, e.g., to acknowledge the UL frame 616.

In some demonstrative aspects, as shown in FIG. 6, the second reserved duration 634 may be initiated, for example, based on a second trigger frame 617 from the AP to the plurality of STAs 602.

In some demonstrative aspects, as shown in FIG. 6, the AP may transmit the trigger frame 617 to solicit a multi station burst of uplink aggregations, for example, after the RTS/CTS exchange. For example, the multi station burst of uplink aggregations may include UL frames 619, e.g., A-MPDUs and/or A-MSDUs, which may be responded by an immediate downlink BA, e.g., a DN BA 618. In some demonstrative aspects, as shown in FIG. 6, the AP may transmit the trigger frame 615, for example, after the reserved duration 634, for example, to indicate to the STAs 602 the start and/or duration of the reserved period 632, which may be allocated for multi-station auxiliary activity.

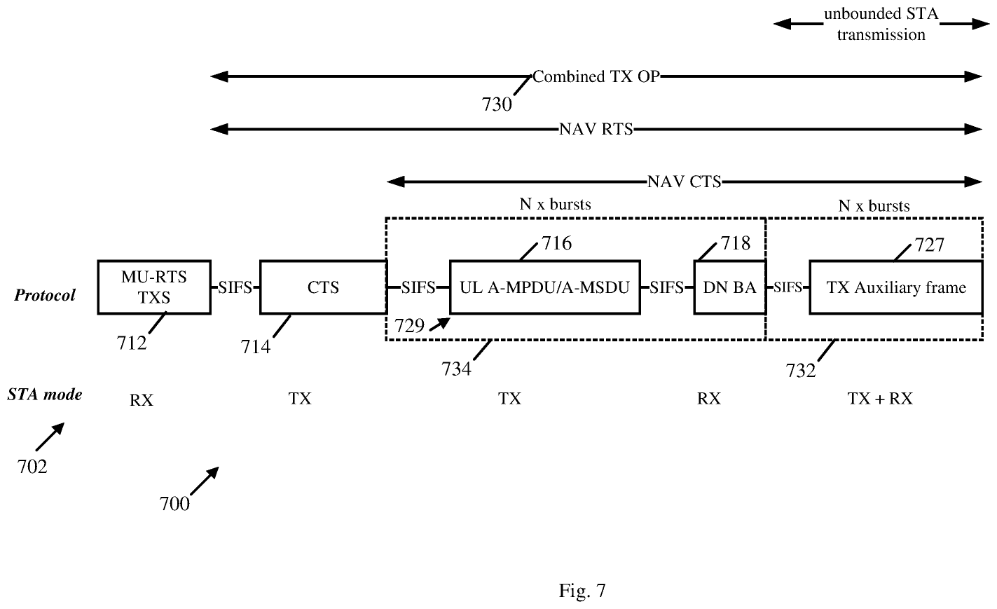

Reference is made to FIG. 7, which schematically illustrates a communication scheme 700 including communications performed by a STA 702 and an AP, in accordance with some demonstrative aspects. For example, device 102 (FIG. 1) may include STA 702, and/or may perform one or more operations and/or functionalities of STA 702; and/or device 140 (FIG. 1) may include the AP, and/or may perform one or more operations and/or functionalities of the AP.

In one example, controller 124 (FIG. 1) may be configured to control, cause and/or trigger the STA implemented by device 102 (FIG. 1) to perform one or more operations of STA 702 according to communication scheme 700, for example, to transmit one or more self-transmissions during a TxOP.

In some demonstrative aspects, as shown in FIG. 7, communication scheme 700 may include an RTS/CTS protection mechanism, e.g., including an exchange of RTS/CTS frames between the AP and STA 702, for example, to reserve a total duration required for TxOP 730, e.g., as described below.

In other aspects, the TxOP 730 may be reserved according to any other additional or alternative protection mechanism, e.g., using any other additional or alternative type of reservation frames.

In some demonstrative aspects, as shown in FIG. 7, STA 702 may process an RTS frame 712, e.g., an MU RTS from the AP, to reserve a wireless communication medium for a TxOP 730, e.g., a combined TxOP 730.

In some demonstrative aspects, TxOP 730 may be based, for example, on a time allocation requested by the STA 702 from the AP.

In some demonstrative aspects, as shown in FIG. 7, TxOP 730 may be initiated and/or triggered by the AP, for example, by transmission of MU RTS frame 712.

In some demonstrative aspects, as shown in FIG. 7, the STA 702 may transmit a CTS frame 714, e.g., in response to the RTS frame 712.

In some demonstrative aspects, as shown in FIG. 7, the time allocation of TxOP 730 may be configured to cover a first reserved duration 732, and a second reserved duration 734.

In some demonstrative aspects, as shown in FIG. 7, the first reserved duration 732 may be after the second reserved duration 734.

In other aspects, the first reserved duration 732 may be before the second reserved duration 734.

In some demonstrative aspects, as shown in FIG. 7, the first reserved duration 732 may be configured for a self-transmission 727, e.g., including at least one Tx auxiliary frame, of the STA 702.

In some demonstrative aspects, as shown in FIG. 7, self-transmission 727 may include a burst of frames, e.g., including N bursts.

In some demonstrative aspects, as shown in FIG. 7, the STA 702 may transmit the self-transmission 727, for example, during the first reserved duration 732.

In some demonstrative aspects, as shown in FIG. 7, the second reserved duration 734 may be configured for communication of non-self-transmissions 729 by the STA 702.

In some demonstrative aspects, as shown in FIG. 7, non-self-transmissions 729 may include a burst of frames, e.g., including N bursts.

In some demonstrative aspects, as shown in FIG. 7, the STA 702 may communicate the non-self-transmissions 729 with the AP, for example, during the second reserved duration 734.

In some demonstrative aspects, as shown in FIG. 7, non-self-transmissions 729 may include an UL frame 716, e.g., an UL A-MPDU or an UL A-MSDU, from STA 702 to the AP.

In some demonstrative aspects, as shown in FIG. 7, non-self-transmissions 729 may include a DL transmission, for example, an ACK frame 718, e.g., a DN BA frame, which may be transmitted from the AP to the STA 702, e.g., to acknowledge the UL frame 716.

In some demonstrative aspects, as shown in FIG. 7, the STA 702 may transmit the non-self-transmission 729, for example, including a burst of uplink aggregations, for example, after the RTS/CTS exchange. For example, the burst of uplink aggregations may include UL frames 716, e.g., A-MPDU and/or an A-MSDU, which may be responded by an immediate downlink BA, e.g., DN BA 718.

In some demonstrative aspects, as shown in FIG. 7, the STA 702 may transmit the self-transmissions 727, e.g., including the burst of frames, for example, during a remainder allocation of the TxOP 730, e.g., after the non-self-transmissions 729.

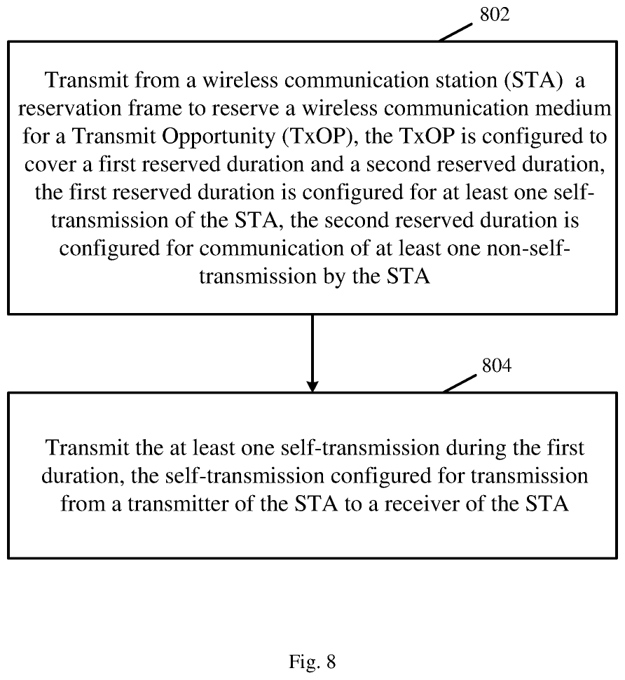

Reference is made to FIG. 8, which schematically illustrates a method of wireless communication during a TxOP, in accordance with some demonstrative aspects. For example, one or more of the operations of the method of FIG. 8 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 802, the method may include transmitting from a STA a reservation frame to reserve a wireless communication medium for a TxOP. For example, the TxOP may be configured to cover a first reserved duration, and a second reserved duration. For example, the first reserved duration may be configured for at least one self-transmission of the STA, and the second reserved duration may be configured for communication of at least one non-self-transmission by the STA. For example, controller 124 (FIG. 1) may be configured to cause, trigger, and/or control device 102 (FIG. 1) to transmit the reservation frame to reserve the wireless communication medium for the TxOP configured to cover the first reserved duration and the second reserved duration, e.g., as described above.

As indicated at block 804, the method may include transmitting the at least one self-transmission during the first duration, the self-transmission configured for transmission from a transmitter of the STA to a receiver of the STA. For example, controller 124 (FIG. 1) may be configured to cause, trigger, and/or control device 102 (FIG. 1) to transmit the at least one self-transmission during the first duration. For example, the self-transmission may be configured for transmission from the transmitter 118 (FIG. 1) to the receiver 116 (FIG. 1), e.g., as described above.

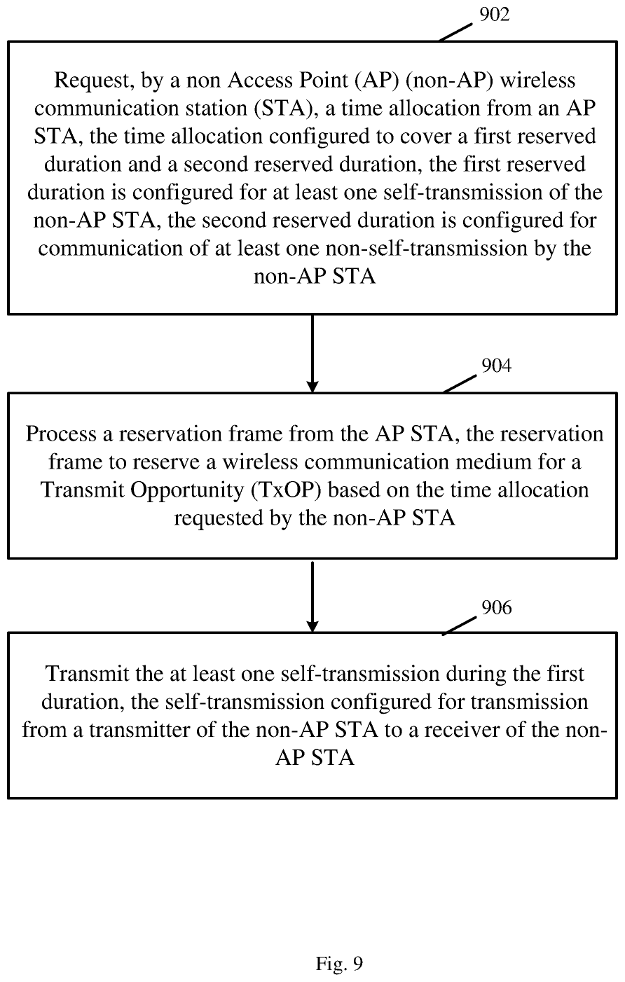

Reference is made to FIG. 9, which schematically illustrates a method of wireless communication during a TxOP, in accordance with some demonstrative aspects. For example, one or more of the operations of the method of FIG. 9 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 902, the method may include requesting, by a non-AP STA, a time allocation from an AP STA, the time allocation configured to cover a first reserved duration and a second reserved duration. For example, the first reserved duration may be configured for at least one self-transmission of the non-AP STA, and the second reserved duration may be configured for communication of at least one non-self-transmission by the non-AP STA. For example, controller 124 (FIG. 1) may be configured to cause, trigger, and/or control device 102 (FIG. 1) to request from device 140 (FIG. 1) the time allocation, which may be configured to cover the first reserved duration and the second reserved duration, e.g., as described above.

As indicated at block 904, the method may include processing a reservation frame from the AP STA, the reservation frame to reserve a wireless communication medium for a TxOP based on the time allocation requested by the non-AP STA. For example, controller 124 (FIG. 1) may be configured to cause, trigger, and/or control the non-AP STA implemented by device 102 (FIG. 1) to process the reservation frame from the AP STA, the reservation frame to reserve the wireless communication medium for the TxOP based on the time allocation requested by the non-AP STA implemented by device 102 (FIG. 1), e.g., as described above.

As indicated at block 906, the method may include transmitting the at least one self-transmission during the first duration, the self-transmission configured for transmission from a transmitter of the non-AP STA to a receiver of the non-AP STA. For example, controller 124 (FIG. 1) may be configured to cause, trigger, and/or control device 102 (FIG. 1) to transmit the at least one self-transmission during the first duration. For example, the self-transmission may be configured for transmission from the transmitter 118 (FIG. 1) to the receiver 116 (FIG. 1), e.g., as described above.

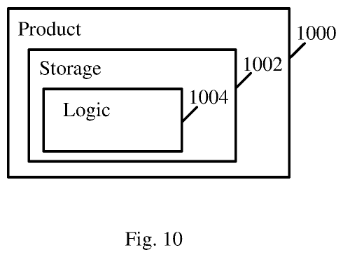

Reference is made to FIG. 10, which schematically illustrates a product of manufacture 1000, in accordance with some demonstrative aspects. Product 1000 may include one or more tangible computer-readable (“machine-readable”) non-transitory storage media 1002, which may include computer-executable instructions, e.g., implemented by logic 1004, operable to, when executed by at least one computer processor, enable the at least one computer processor to implement one or more operations at device 102 (FIG. 1), device 140 (FIG. 1), device 160 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1); to cause device 102 (FIG. 1), device 140 (FIG. 1), device 160 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1) to perform, trigger and/or implement one or more operations and/or functionalities; and/or to perform, trigger and/or implement one or more operations and/or functionalities described with reference to the FIGS. 1-9, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 1000 and/or machine readable storage media 1002 may include one or more types of computer-readable storage media capable of storing data, including volatile memory, non-volatile memory, removable or non-removable memory, erasable or non-erasable memory, writeable or re-writeable memory, and the like. For example, machine readable storage media 1002 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a hard drive, an optical disk, a magnetic disk, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 1004 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 1004 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes an apparatus comprising logic and circuitry configured to cause a wireless communication station (STA) to transmit a reservation frame to reserve a wireless communication medium for a Transmit Opportunity (TxOP), wherein the TxOP is configured to cover a first reserved duration and a second reserved duration, wherein the first reserved duration is configured for at least one self-transmission of the STA, wherein the second reserved duration is configured for communication of at least one non-self-transmission by the STA; and transmit the at least one self-transmission during the first duration, the self-transmission configured for transmission from a transmitter of the STA to a receiver of the STA.

Example 2 includes the subject matter of Example 1, and optionally, wherein the apparatus is configured to cause the STA to communicate the at least one non-self-transmission with an other STA during the second reserved duration.

Example 3 includes the subject matter of Example 2, and optionally, wherein the at least one non-self-transmission comprises at least one of a non-self transmitted frame transmitted from the transmitter of the STA to the other STA, or a non-self received frame received from the other STA at the receiver of the STA.

Example 4 includes the subject matter of any one of Examples 1-3, and optionally, wherein the apparatus is configured to cause the STA to determine a duration of the TxOP based on a duration of the at least one self-transmission of the STA and the at least one non-self-transmission by the STA, and to set a duration field in the reservation frame to indicate the duration of the TxOP.

Example 5 includes the subject matter of any one of Examples 1-4, and optionally, wherein the first reserved duration is after the second reserved duration.

Example 6 includes the subject matter of any one of Examples 1-4, and optionally, wherein the first reserved duration is before the second reserved duration.

Example 7 includes the subject matter of any one of Examples 1-4, and optionally, wherein the first reserved duration is configured for at least one first self-transmission of the STA, wherein the second reserved duration is after the first reserved duration, the second reserved duration configured for communication of at least one non-self-transmission by the STA, and wherein the TxOP is configured to cover a third reserved duration after the second reserved duration, the third reserved duration is configured for at least one second self-transmission of the STA.

Example 8 includes the subject matter of any one of Examples 1-7, and optionally, wherein the at least one self-transmission comprises a self-measurement transmission, which is configured for a self-measurement at the STA based on reception of the self-transmission at the receiver of the STA.

Example 9 includes the subject matter of any one of Examples 1-8, and optionally, wherein the at least one self-transmission comprises a proximity sensing transmission configured for proximity sensing at the STA based on reception of the self-transmission at the receiver of the STA.

Example 10 includes the subject matter of any one of Examples 1-9, and optionally, wherein the at least one self-transmission comprises a channel-sounding transmission configured for a channel-sounding-based measurement at the STA based on reception of the self-transmission at the receiver of the STA.

Example 11 includes the subject matter of any one of Examples 1-10, and optionally, wherein the at least one self-transmission comprises a Null Data Packet (NDP).

Example 12 includes the subject matter of any one of Examples 1-11, and optionally, wherein the at least one self-transmission comprises a calibration transmission configured for calibration of at least one of the transmitter of the STA or the receiver of the STA.

Example 13 includes the subject matter of any one of Examples 1-12, and optionally, wherein the at least one self-transmission comprises an unbounded transmission, which is unbounded by transmit limitations applied to the at least one non-self-transmission.

Example 14 includes the subject matter of any one of Examples 1-13, and optionally, wherein the at least one self-transmission comprises a built-in testing transmission configured for a built-in test at the STA.

Example 15 includes the subject matter of any one of Examples 1-14, and optionally, wherein the at least one self-transmission comprises an auxiliary transmission configured for one or more auxiliary operations at the STA based on reception of the auxiliary transmission at the receiver of the STA.

Example 16 includes the subject matter of any one of Examples 1-15, and optionally, wherein the at least one self-transmission comprises a burst of frames.

Example 17 includes the subject matter of any one of Examples 1-16, and optionally, wherein the second reserved duration is equal to or longer than a duration of a Media Access Control (MAC) frame.

Example 18 includes the subject matter of any one of Examples 1-17, and optionally, wherein the non-self-transmission comprises at least one non-self Media Access Control (MAC) frame, which is communicated between the STA and an other STA.

Example 19 includes the subject matter of any one of Examples 1-18, and optionally, wherein the reservation frame comprises a Request to Send (RTS).

Example 20 includes the subject matter of Example 19, and optionally, wherein the apparatus is configured to cause the STA to initiate the TxOP based on receipt of a Clear to Send (CTS) in response to the RTS.

Example 21 includes the subject matter of any one of Examples 1-20, and optionally, wherein the STA comprises a non Access Point (AP) (non-AP) STA, wherein the reservation frame comprises a reservation frame from the non-AP STA to an AP STA, wherein the at least one non-self-transmission comprises an Uplink (UL) frame from the non-AP STA to the AP STA and an Acknowledgement (ACK) from the AP STA to the non-AP STA.

Example 22 includes the subject matter of any one of Examples 1-21, and optionally, wherein the STA comprises an Access Point (AP) STA.

Example 23 includes the subject matter of any one of Examples 1-22, and optionally, comprising at least one radio comprising the transmitter of the STA and the receiver of the STA.

Example 24 includes the subject matter of Example 23, and optionally, comprising one or more antennas connected to the radio, and a processor to execute instructions of an operating system of the STA.

Example 25 includes an apparatus comprising logic and circuitry configured to cause a non Access Point (AP) (non-AP) wireless communication station (STA) to request a time allocation from an AP STA, the time allocation configured to cover a first reserved duration and a second reserved duration, wherein the first reserved duration is configured for at least one self-transmission of the non-AP STA, wherein the second reserved duration is configured for communication of at least one non-self-transmission by the non-AP STA; process a reservation frame from the AP STA, the reservation frame to reserve a wireless communication medium for a Transmit Opportunity (TxOP) based on the time allocation requested by the non-AP STA; and transmit the at least one self-transmission during the first duration, the self-transmission configured for transmission from a transmitter of the non-AP STA to a receiver of the non-AP STA.

Example 26 includes the subject matter of Example 25, and optionally, wherein the apparatus is configured to cause the non-AP STA to communicate the at least one non-self-transmission during the second reserved duration.

Example 27 includes the subject matter of Example 25 or 26, and optionally, wherein the at least one non-self-transmission comprises a triggered Peer to Peer (P2P) transmission between the non-AP STA and another non-AP STA.

Example 28 includes the subject matter of any one of Examples 25-27, and optionally, wherein the at least one non-self-transmission comprises an Uplink (UL) non-self frame from the transmitter of the non-AP STA to the AP STA, and an Acknowledgement (ACK) from the non-AP STA to the AP STA.

Example 29 includes the subject matter of any one of Examples 25-28, and optionally, wherein the apparatus is configured to cause the non-AP STA to determine a duration of the time allocation requested by the non-AP STA based on a duration of the at least one self-transmission of the non-AP STA and the at least one non-self-transmission by the non-AP STA.

Example 30 includes the subject matter of any one of Examples 25-29, and optionally, wherein the first reserved duration is after the second reserved duration.

Example 31 includes the subject matter of any one of Examples 25-29, and optionally, wherein the first reserved duration is before the second reserved duration.

Example 32 includes the subject matter of any one of Examples 25-29, and optionally, wherein the first reserved duration is configured for at least one first self-transmission of the non-AP STA, wherein the second reserved duration is after the first reserved duration, the second reserved duration configured for communication of at least one non-self-transmission by the non-AP STA, and wherein the time allocation is configured to cover a third reserved duration after the second reserved duration, the third reserved duration is configured for at least one second self-transmission of the non-AP STA.

Example 33 includes the subject matter of any one of Examples 25-32, and optionally, wherein the at least one self-transmission comprises a self-measurement transmission, which is configured for a self-measurement at the non-AP STA based on reception of the self-transmission at the receiver of the non-AP STA.

Example 34 includes the subject matter of any one of Examples 25-33, and optionally, wherein the at least one self-transmission comprises a proximity sensing transmission configured for proximity sensing at the non-AP STA based on reception of the self-transmission at the receiver of the non-AP STA.

Example 35 includes the subject matter of any one of Examples 25-34, and optionally, wherein the at least one self-transmission comprises a channel-sounding transmission configured for a channel-sounding-based measurement at the non-AP STA based on reception of the self-transmission at the receiver of the non-AP STA.

Example 36 includes the subject matter of any one of Examples 25-35, and optionally, wherein the at least one self-transmission comprises a Null Data Packet (NDP).

Example 37 includes the subject matter of any one of Examples 25-36, and optionally, wherein the at least one self-transmission comprises a calibration transmission configured for calibration of at least one of the transmitter of the non-AP STA or the receiver of the non-AP STA.

Example 38 includes the subject matter of any one of Examples 25-37, and optionally, wherein the at least one self-transmission comprises an unbounded transmission, which is unbounded by transmit limitations applied to the at least one non-self-transmission.

Example 39 includes the subject matter of any one of Examples 25-38, and optionally, wherein the at least one self-transmission comprises a built-in testing transmission configured for a built-in test at the non-AP STA.

Example 40 includes the subject matter of any one of Examples 25-39, and optionally, wherein the at least one self-transmission comprises an auxiliary transmission configured for one or more auxiliary operations at the non-AP STA based on reception of the auxiliary transmission at the receiver of the non-AP STA.

Example 41 includes the subject matter of any one of Examples 25-40, and optionally, wherein the at least one self-transmission comprises a burst of frames.

Example 42 includes the subject matter of any one of Examples 25-41, and optionally, wherein the second reserved duration is equal to or longer than a duration of a Media Access Control (MAC) frame.

Example 43 includes the subject matter of any one of Examples 25-42, and optionally, wherein the non-self-transmission comprises at least one non-self Media Access Control (MAC) frame, which is communicated between the non-AP STA and the AP STA.

Example 44 includes the subject matter of any one of Examples 25-43, and optionally, wherein the apparatus is configured to cause the non-AP STA to initiate the first reserved duration based on a first trigger frame from the AP STA, and to initiate the second duration based on a second trigger frame from the AP STA.

Example 45 includes the subject matter of any one of Examples 25-44, and optionally, wherein the reservation frame comprises a Request to Send (RTS).

Example 46 includes the subject matter of Example 45, and optionally, wherein the apparatus is configured to cause the non-AP STA to transmit a Clear to Send (CTS) in response to the RTS.

Example 47 includes the subject matter of any one of Examples 25-46, and optionally, comprising at least one radio comprising the transmitter of the non-AP STA and the receiver of the non-AP STA.

Example 48 includes the subject matter of Example 47, and optionally, comprising one or more antennas connected to the radio, and a processor to execute instructions of an operating system of the non-AP STA.

Example 49 comprises a wireless communication device comprising the apparatus of any of Examples 1-48.

Example 50 comprises an apparatus comprising means for executing any of the described operations of any of Examples 1-48.

Example 51 comprises a product comprising one or more tangible computer-readable non-transitory storage media comprising instructions operable to, when executed by at least one processor, enable the at least one processor to cause a wireless communication device to perform any of the described operations of any of Examples 1-48.

Example 52 comprises an apparatus comprising: a memory interface; and processing circuitry configured to: perform any of the described operations of any of Examples 1-48.

Example 53 comprises a method comprising any of the described operations of any of Examples 1-48.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising logic and circuitry configured to cause a wireless communication station (STA) to:
transmit a reservation frame to reserve a wireless communication medium for a Transmit Opportunity (TxOP), wherein the TxOP is configured to cover a first reserved duration and a second reserved duration, wherein the first reserved duration is configured for at least one self-transmission of the STA, wherein the second reserved duration is configured for communication of at least one non-self-transmission by the STA; and
transmit the at least one self-transmission during the first duration, the self-transmission configured for transmission from a transmitter of the STA to a receiver of the STA.

2. The apparatus of claim 1 configured to cause the STA to communicate the at least one non-self-transmission with an other STA during the second reserved duration.

3. The apparatus of claim 1 configured to cause the STA to determine a duration of the TxOP based on a duration of the at least one self-transmission of the STA and the at least one non-self-transmission by the STA, and to set a duration field in the reservation frame to indicate the duration of the TxOP.

4. The apparatus of claim 1, wherein the first reserved duration is after the second reserved duration.

5. The apparatus of claim 1, wherein the first reserved duration is before the second reserved duration.

6. The apparatus of claim 1, wherein the first reserved duration is configured for at least one first self-transmission of the STA, wherein the second reserved duration is after the first reserved duration, the second reserved duration configured for communication of at least one non-self-transmission by the STA, and wherein the TxOP is configured to cover a third reserved duration after the second reserved duration, the third reserved duration is configured for at least one second self-transmission of the STA.

7. The apparatus of claim 1, wherein the at least one self-transmission comprises a self-measurement transmission, which is configured for a self-measurement at the STA based on reception of the self-transmission at the receiver of the STA.

8. The apparatus of claim 1, wherein the at least one self-transmission comprises a proximity sensing transmission configured for proximity sensing at the STA based on reception of the self-transmission at the receiver of the STA.

9. The apparatus of claim 1, wherein the at least one self-transmission comprises a channel-sounding transmission configured for a channel-sounding-based measurement at the STA based on reception of the self-transmission at the receiver of the STA.

10. The apparatus of claim 1, wherein the at least one self-transmission comprises a calibration transmission configured for calibration of at least one of the transmitter of the STA or the receiver of the STA.

11. The apparatus of claim 1, wherein the at least one self-transmission comprises an unbounded transmission, which is unbounded by transmit limitations applied to the at least one non-self-transmission.

12. The apparatus of claim 1, wherein the at least one self-transmission comprises a built-in testing transmission configured for a built-in test at the STA.

13. The apparatus of claim 1, wherein the at least one self-transmission comprises an auxiliary transmission configured for one or more auxiliary operations at the STA based on reception of the auxiliary transmission at the receiver of the STA.

14. The apparatus of claim 1, wherein the second reserved duration is equal to or longer than a duration of a Media Access Control (MAC) frame.

15. The apparatus of claim 1, wherein the STA comprises a non Access Point (AP) (non-AP) STA, wherein the reservation frame comprises a reservation frame from the non-AP STA to an AP STA, wherein the at least one non-self-transmission comprises an Uplink (UL) frame from the non-AP STA to the AP STA and an Acknowledgement (ACK) from the AP STA to the non-AP STA.

16. The apparatus of claim 1, wherein the STA comprises an Access Point (AP) STA.

17. The apparatus of claim 1 comprising at least one radio comprising the transmitter of the STA and the receiver of the STA.

18. The apparatus of claim 17 comprising one or more antennas connected to the radio, and a processor to execute instructions of an operating system of the STA.

19. A product comprising one or more tangible computer-readable non-transitory storage media comprising instructions operable to, when executed by at least one processor, enable the at least one processor to cause a wireless communication station (STA) to:
transmit a reservation frame to reserve a wireless communication medium for a Transmit Opportunity (TxOP), wherein the TxOP is configured to cover a first reserved duration and a second reserved duration, wherein the first reserved duration is configured for at least one self-transmission of the STA, wherein the second reserved duration is configured for communication of at least one non-self-transmission by the STA; and
transmit the at least one self-transmission during the first duration, the self-transmission configured for transmission from a transmitter of the STA to a receiver of the STA.

20. The product of claim 19, wherein the instructions, when executed, cause the STA to determine a duration of the TxOP based on a duration of the at least one self-transmission of the STA and the at least one non-self-transmission by the STA, and to set a duration field in the reservation frame to indicate the duration of the TxOP.

21. An apparatus comprising logic and circuitry configured to cause a non Access Point (AP) (non-AP) wireless communication station (STA) to:
request a time allocation from an AP STA, the time allocation configured to cover a first reserved duration and a second reserved duration, wherein the first reserved duration is configured for at least one self-transmission of the non-AP STA, wherein the second reserved duration is configured for communication of at least one non-self-transmission by the non-AP STA;
process a reservation frame from the AP STA, the reservation frame to reserve a wireless communication medium for a Transmit Opportunity (TxOP) based on the time allocation requested by the non-AP STA; and
transmit the at least one self-transmission during the first duration, the self-transmission configured for transmission from a transmitter of the non-AP STA to a receiver of the non-AP STA.

22. The apparatus of claim 21, wherein the at least one non-self-transmission comprises a triggered Peer to Peer (P2P) transmission between the non-AP STA and another non-AP STA.

23. The apparatus of claim 21, wherein the at least one non-self-transmission comprises an Uplink (UL) non-self frame from the transmitter of the non-AP STA to the AP STA, and an Acknowledgement (ACK) from the non-AP STA to the AP STA.

24. The apparatus of claim 21 configured to cause the non-AP STA to determine a duration of the time allocation requested by the non-AP STA based on a duration of the at least one self-transmission of the non-AP STA and the at least one non-self-transmission by the non-AP STA.

25. The apparatus of claim 21, wherein the first reserved duration is configured for at least one first self-transmission of the non-AP STA, wherein the second reserved duration is after the first reserved duration, the second reserved duration configured for communication of at least one non-self-transmission by the non-AP STA, and wherein the time allocation is configured to cover a third reserved duration after the second reserved duration, the third reserved duration is configured for at least one second self-transmission of the non-AP STA.
